(19) United States
(12) Patent Application Publication
(10) Pub. No.: US 2005/0021763 A1
(43) Pub. Date: Jan. 27, 2005

(54) Method for providing buying/presenting information for communication system and telephone exchange apparatus using the communication system

(76) Inventor: Takahiro Izawa, Hachioji-shi (JP)

Correspondence Address: Finnegan, Henderson, Farabow,;Garrett & Dunner, L.L.P., 1300 I Street, N.W., Washington, DC, 20005-3315, US

(21) Appl. No.: 10/855,389

(22) Filed: May 28, 2004

(30) Foreign Application Priority Data
May 30, 2003 (JP) 2003-156022

(51) Int. Cl. G06F 15/16

(52) U.S. Cl. 709/227; 705/1

(57) ABSTRACT

A method includes acquiring creation support information for creating the buying/presenting information in a data format of the control program at the purchasing center, creating the buying/presenting information based on the creation support information, obtaining the buying/presenting information at the user apparatus, recording the obtained buying/presenting information on a recording medium at the user apparatus, and reading out the buying/presenting information from the recording medium in accordance with an initially set condition and selectively transmitting the buying/presenting information to the plurality of extension terminals at the user apparatus.

### CROSS-REFERENCE TO RELATED APPLICATIONS

This application is based upon and claims the benefit of priority from prior Japanese Patent Application No. 2003-156022, filed May 30, 2003, the entire contents of which are incorporated herein by reference.

### BACKGROUND OF THE INVENTION

1. Field of the Invention

The present invention relates to a buying/presenting information providing method for allowing service and commodities to be bought through a communication network in a communication system having a telephone exchange apparatus including a private branch exchange (PBX), key telephone system, and so on, and to the telephone exchange apparatus used for its communication system.

2. Description of the Related Art

The telephone exchange apparatus, such as the PBX and key telephone system, has been used, in greater numbers, in the working offices, schools and business establishments. This type of telephone exchange apparatus includes, for example, telephone sets as extension terminals and voice communication can be conducted through an exchange connection between the extension terminal and an external communication network, such as a public network, and between the extension terminal and an associated extension terminal, and so on.

In the telephone exchange apparatus above, for example, shopping information (advertisement) is distributed to the respective extension terminals in a form to have a telephone number or IP address attached thereto to allow a call/connection to be made to an associated purchasing center (advertiser) on the communication network. In the extension terminal, if any user wishing to make an on-line purchase inputs a predetermined operation, then he or she can make a call/connection to the purchasing center and, in this way, it is possible to finish a purchasing procedure (Jpn. Pat. Appln. KOKAI Publication No. 2000-330940).

In the telephone exchange apparatus above, however, in order to realize on-line purchasing service for each advertiser or each AD. content, it is necessary to change the setting of the apparatus as well as the setting of a corresponding program in the apparatus. In the creation of a new AD. and setting of its contents, therefore, it is necessary for the advertiser to study and review the type of telephone exchange apparatus owned by the user and its setting environment as well as the data format of the control program involved. It takes lots of time and costs to provide a new advertisement to the user and a greater burden is placed on the advertiser since this demands his or her skill and expertise on this field. Further, the user cannot promptly see the new contents of a new or updated advertisement.

### BRIEF SUMMARY OF THE INVENTION

The object of the present invention is to provide a buying/presenting information providing method for a communication system which can promptly and properly provide new or version-up buying/presenting information to the user, reduce a cost and labor involved in the creation of the buying/presenting information on the information creator side and ensure more enhanced entertainment to the user, more stimulated buying desire for commodities and more extensively available service.

According to an aspect of the present invention, there is provided a method for use in a communication system which includes an user apparatus equipped with an exchange apparatus connected to a plurality of extension terminals, and a purchasing center adapted to communicate with the exchange apparatus together with the extension terminal via a communication network based on a control program be setting the exchange apparatus, the extension terminal receiving a buying/presenting information allowing the buying at least one of commodities and service through the communication network, and making a call/connection to the purchasing center through the communication network based on a purchasing center-connecting information contained in the buying/presenting information and taking a buying procedure, in response to a buying instruction, comprising: acquiring creation support information for creating the buying/presenting information in a data format of the control program at the purchasing center; creating the buying/presenting information based on the creation support information; obtaining the buying/presenting information at the user apparatus; recording the obtained buying/presenting information on a recording medium at the user apparatus; and reading out the buying/presenting information from the recording medium in accordance with an initially set condition and selectively transmitting the buying/presenting information to the plurality of extension terminals at the user apparatus.

According to another aspect of the present invention, there is provided A telephone exchange apparatus connected to a plurality of extension terminals, and adapted to communicate with a purchasing center via a communication network based on an initially set control program, the extension terminal receiving a buying/presenting information allowing the buying at least one of commodities and service through the communication network, and making a call/connection to a purchasing center through the communication network based on a purchasing center-connecting information contained in the buying/presenting information and taking a buying procedure, in response to a buying instruction, the telephone exchange apparatus comprising: an acquiring device configured to selectively acquire the buying/presenting information created in a data format of the control program data by the purchasing center; a recorder which records the buying/presenting information on a recording medium; and a controller which controls to read out the buying/presenting information from the recording medium in accordance with an initially set execution condition and selectively transmit the buying/presenting information to the plurality of extension terminal.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

FIG. 1 is a block diagram showing an exchange system for carrying out one embodiment related to an ad. script providing method;

FIG. 2 is a diagram showing contents of ad. script used one embodiment;

FIG. 3 is a sequence showing the processing steps and processing contents for carrying out an ad. script providing method;

FIG. 4 is a block diagram showing a flow of the processing in the PBX 1;

FIG. 5 is a flowchart showing the processing procedure and processing contents of the CPU 14;

The accompanying drawings, which are incorporated in and constitute a part of the specification, illustrate presently preferred embodiments of the invention, and together with the general description given above and the detailed description of the preferred embodiments given below, serve to explain the principles of the invention.

### DETAILED DESCRIPTION OF THE INVENTION

With reference to the drawing, an explanation will be made below about an embodiment of the present invention.

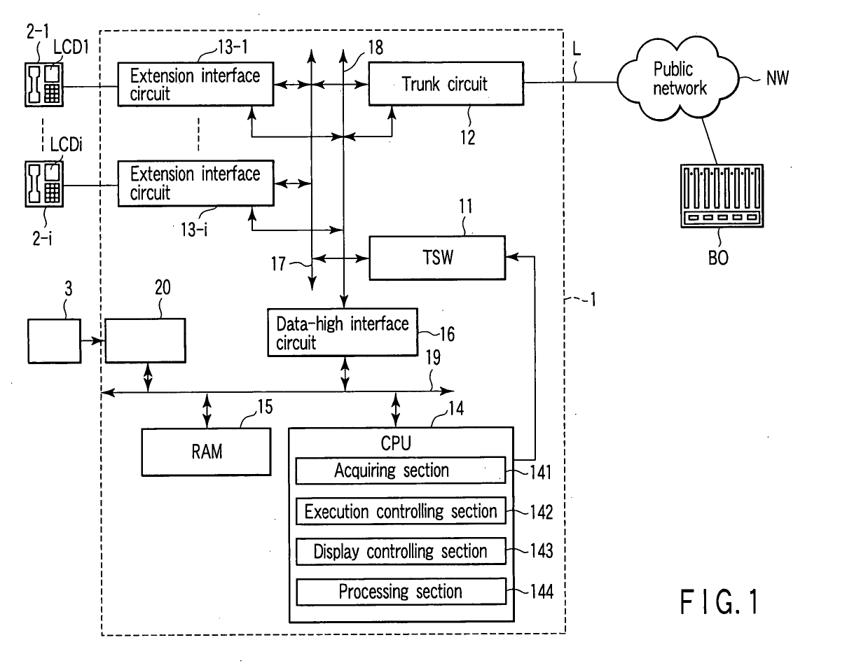

FIG. 1 is a schematic view showing an exchange system for carrying out one embodiment related to an ad. script providing method.

The exchange system is so constructed that, as shown in FIG. 1, a plurality of (an i maximum number of) extension terminals 2 (2-1 to 2-i) are freely connected to a private branch exchange (hereinafter referred to as a PBX 1). Display devices LCDs (LCD to LCDi) are provided respectively, on the extension terminals 2-1 to 2-i.

Further, the PBX 1 includes a time switch 11, a trunk circuit 12, a plurality of (an i number of) extension interface circuits 13 (13-1 to 13i), a controller 14 (hereinafter referred to as a CPU 14), a memory section 15 (hereinafter referred to as a RAM 15) and a data highway interface circuit 16. The time switch 11, trunk circuit 12 and extension interface circuit 13 are mutually connected through a PCM highway 17.

The trunk circuit 12, extension interface circuits 13 and data highway interface circuit 16 are mutually connected through a data highway 18. Further, the CPU 14, RAM 15 and data highway interface 16 are mutually connected through a CPU bus 19. It is to be noted that the time switch 11 is connected directly to the CPU 14. A memory medium slot 20 is connected to an external memory 3 including a magnetic disk and an optical disk such as a compact disk (CD) and, as an input/output device, to the CPU 19. It is to be noted that, in place of the external memory 3, use may be made of a built-in memory and hard disk.

The time switch 11 is such that, by changing a time slot on the PCM highway 17 under the control of the CPU 14, exchange connection is freely made between the trunk circuit 12 and the corresponding extension interface circuit 13.

A trunk line L connected to a public network NW is connected, as required, to the trunk circuit 12. The trunk circuit 12 acts as an interface relating to the connected trunk line L. Further, the trunk circuit 12 allows various control information relating to the action of the interface to be passed to and from the CPU 14 through the data highway 18, data highway interface circuit 16 and CPU bus 19.

The extension terminal 2 is connected as required to the associated extension interface circuit 13. The extension interface circuit 13 acts as the extension interface relating to the connected extension terminal 2. The extension interface action includes an extraction, from the PCM highway 17, of a PCM signal which is output from the extension terminal 2, as well as the checking of the state of the extension terminal 2, delivery of various signals to the extension terminal 2, and so on. Further, the extension interface circuit 13 allows various control information relating to the extension interface action to be passed to and from the CPU 14 through the data highway 18, data highway interface circuit 16 and CPU bus 19.

The CPU 14 performs processing according to the control program stored in the RAM 15 and, in this way, generally controls the time switch 11, trunk circuit 12 and extension interface circuit 13 and realizes an action as the PBX 1.

The RAM 15 stores the control program of the CPU 14 and various kinds of data, etc., which are used permanently.

The data highway interface circuit 16 allows data to be passed between the data highway 18 and the CPU bus 19.

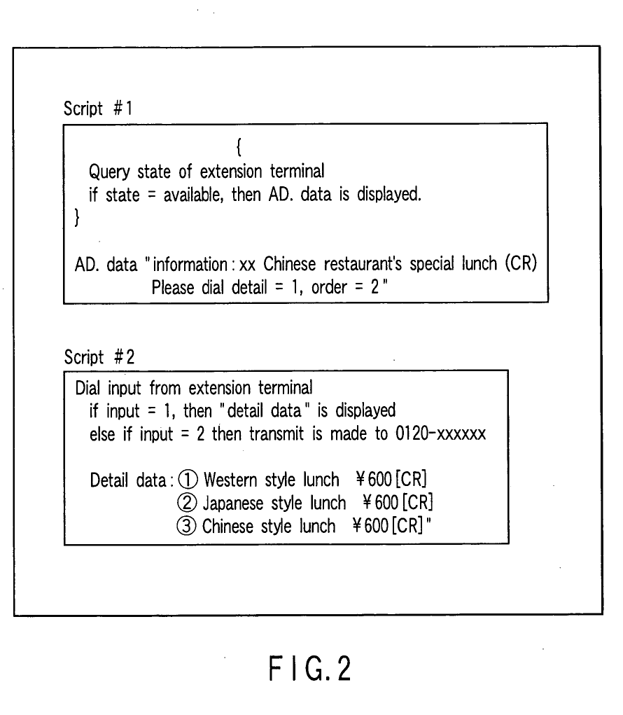

Incidentally, the CPU 14 of this embodiment includes a script acquiring section 141 (hereinafter referred to an acquiring section 141), a script execution controlling section 142 (hereinafter referred to as an execution controlling section 142, display controlling section 143 and a call processing section 144 (hereinafter referred to as a processing section 144). Out of these, the acquiring section 141 is such that, when the external memory 3 with an AD. script stored as buying/presenting information is connected to the memory medium slot 20 and a read-in instruction is input, the AD. script is read out from the external memory 3 and it is recorded on the RAM 15. At this time, in accordance with an execution condition setting instruction, execution condition data is recorded on the RAM 15 in such a way as to be matched to the AD. script. This AD. script contains, as shown in FIG. 2, information representing an AD. content relating to a lunch menu, select instruction information and purchasing center BO-connecting information and is stored as execution condition data for example in such a way as to be matched to ┌11:30 A.M.┘.

The execution controlling section 142 reads out the AD. script which is stored in the RAM 15 in accordance with the corresponding execution condition data and, based on the AD. script, controls the display control section 143 and performs ad. display processing relative to the respective extension terminal 2. Where, in this AD. display state, a transmit operation is input toward the purchasing center BO, the processing section 144 is controlled such that a call/connection is made to the purchasing center BO, that is, a connection destination contained in the AD. script.

Upon receipt of an AD. display instruction under the control of the execution controlling section 142, the display controlling section 143 has its AD. content displayed on the corresponding display device LCD on the extension terminal 2. Further, upon receipt of an instruction for displaying a detail of AD. content under the control of the execution controlling section 142, the detail of the content is displayed on the display device LCD on the extension terminal 2.

The processing controlling section 144 controls the time switch 11 to make a connection between the mutual extension interface circuits 13 and between the extension interface circuit 13 and the trunk circuit 12 and, upon receipt of a call/connection instruction under the control of the execution controlling section 142, transmit a call signal toward the purchasing center Bo over the public network NW. When the purchasing center BO responds to the call, a communication link is created between the purchasing center BO and a requesting extension terminal 2. In this way, talking can be made between the purchasing center BO and the requesting extension terminal 2.

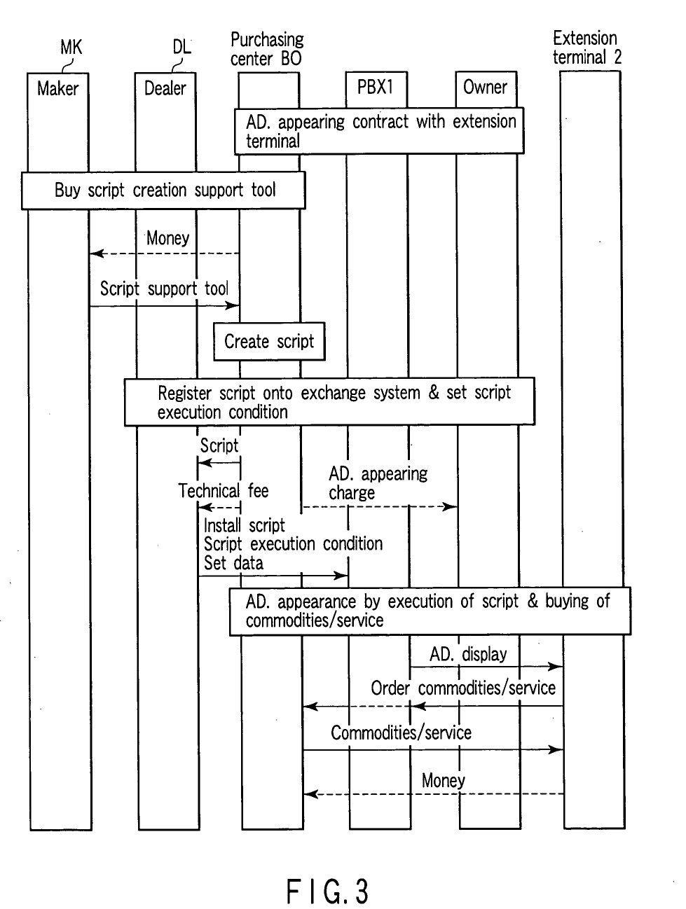

Now, an explanation will be made below about the AD. script providing method in connection with the system thus structured. FIG. 3 shows a sequence showing the processing steps and processing contents among the PBX 1, extension terminal 2, purchasing center BO, exchange apparatus maker MK and exchange dealer DL.

First, the purchasing center BO makes an AD. contract with an owner of the PBX 1 so as to effect an AD. display on the requesting extension terminals. At this time, the purchasing center Bo registers, on a client database, attribute information including, for example, the name and address of the owner and a telephone number or mail address, etc., of his or her contact destination, as well as the kinds of PBX's owned by the user and data formats of the control programs.

Then, the purchasing center BO buys, from the exchange apparatus maker MK, a script creation support tool for displaying an advertisement on the extension terminal 2. At this time, the purchasing center BO informs the exchange apparatus maker MK of the kind of PBX 1 as the AD. display destination and data format of its control program and buys a PBX 1-compatible creation support tool. It is to be noted that the tool may be bought via the exchange apparatus dealer DL.

The creation support tool displays, as select items, information elements necessary to instruct how to operate the PBX 1 to, for example, a script creator and enables a script sentence to be created in accordance with the select items from the creator.

The script constitutes a means for securing a link to the PBX 1 and has to be created with the use of a pre-defined grammar and languages to allow the PBX 1 to understand these contents. In order to allow even a person unfamiliar with the creation of a script to accurately and efficiently do so, it is important to prepare a support tool in the practice of the present invention.

The script creator on the purchasing center BO creates an AD. script with the use of a creation support tool. If, at this time, with respect to, for example, those select items of an operation=(1) an outgoing call (2) connected (3) a display, a kind=(1) an extension line (2) a trunk line, a range=(1) a designation (2) a whole, and a content=┌free description┘, the script creator enters the operation=(1) an outgoing call, kind (2) a trunk line, range=(1) designation and content=┌0120-xxxx┘, then a script is created as a script for allowing an outgoing call to be directed over the trunk line toward the ┌0120-xxxx┘. If the script creator enters the operation=(3) a display, a kind=(1) extension line, range=(2) a whole and content=┌xx Chinese restaurant's special lunch┘, then a script is created displaying the ┌xx Chinese restaurant's special lunch┘ on the display devices LCD of all the extension terminals 2. In this way, a new AD. script or a version-up AD. script is promptly created by this simple processing. It is to be noted that the creation support tool is directed to assisting a person unfamiliar with the creation of a script and it is also possible to create a script without a help from the tool.

Then, the purchasing center BO passes the created AD. script by any proper means to an exchange dealer DL, requesting the setting of the AD. script to the contracting PBX 1. In this case, the created AD. script is passed to the external memory 3 while being recorded. The thus requested exchange dealer DL sets the created AD. script to the PBX 1 and the execution condition data of the script and collects that registration technical fee from the purchasing center BO. The owner of the PBX 1 collets the AD. appearing expense from the purchasing center BO.

In operation, the PBX 1 thus set with the AD. script performs processing based on the AD. script and in accordance with the set execution condition. In this way, the user on the extension terminal 2 can see the AD. information on the display device LCD of his or her own extension terminal 2 and, in accordance with the AD. information, places an order with the purchasing center BO for commodities or service.

And the script creator on the purchasing center BO receives money as an expense for the offering of the commodities or service to the extension terminal 2.

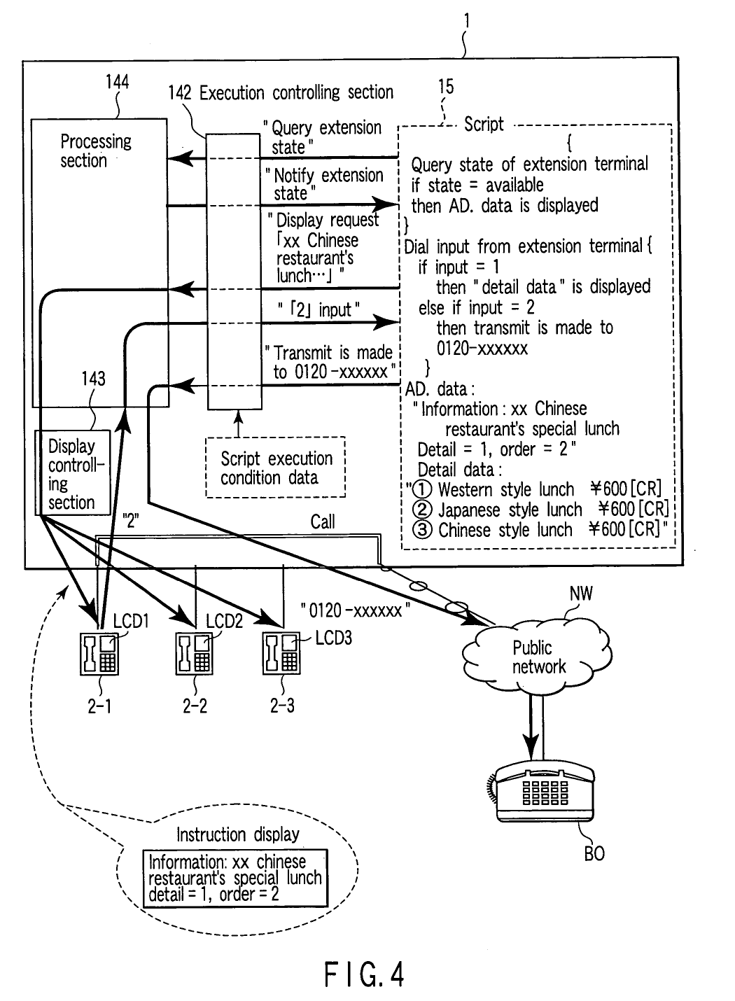

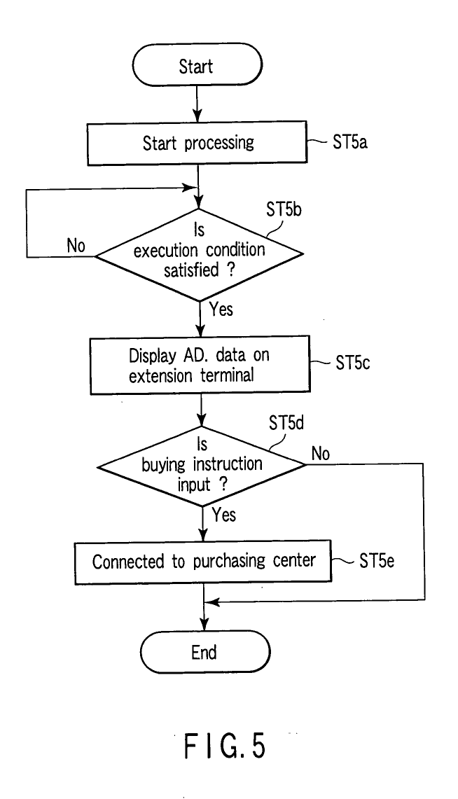

Now an explanation will be made below about the processing operation of the PBX 1 when the AD. script providing method above is executed. FIG. 4 is a block diagram showing a flow of the processing in the PBX 1 and FIG. 5 is a flowchart showing the processing procedure and processing contents of the CPU 14.

When a power supply is started, the CPU 14 performs the known start processing (step ST5a) and it is decided whether or not the set execution condition is satisfied (step ST5b). Here, as an execution condition, there exist, for example, an interlock with a system starting, the designation of the execution time, and the starting of a script execution using, as a trigger, the inputting of a key word by the dial operation from the user on the extension terminal 2. Here, the state of the execution terminal 2 is used as the execution condition.

That is, the call states of all the extension terminals 2 are checked and, if there is any ┌available┘ state (Yes). The CPU 14 reads in the AD, script which is stored in the RAM 15. In accordance with the content of the AD. script 9 a banner AD. ┌Information: the xx Chinese restaurant's special lunch a detail=1 an order=2┘ is displayed, through the display controlling section 143, on the display devices LCD 1, LCD 2 and LCD 3 of those available extension terminals 2-1, 2-2 and 2-3, respectively (step ST5c) and it is decided whether or not any buying instruction is input (step ST5d). It is to be noted that the AD. script contains abridged connection information ┌2┘ for specifying the purchasing center BO-connecting information.

Let it be assumed that, in this state, the user on the extension terminal 2-1 for example enters a dial ┌2┘ as an input for a lunch order in accordance with the content of the banner AD. (Yes). Then, the CPU 14 notifies the dial ┌2┘ which is received at the processing section 144 to the execution controlling section 142 and, in accordance with the content of the script, controls the processing section 144 so as to make an outgoing call toward the purchasing center BO (step ST5e). When the purchasing center BO responds to the call, the CPU 14 creates a link between the purchasing center BO and the requesting extension terminal 2-1, allowing a talk therebetween.

In this way, the user on the extension terminal 2-1 can talk with a person on the purchasing center BO and place an order with him or her for lunch.

At step ST5d, if, in place of inputting a buying instruction, the user on the extension terminal 2 performs any other processing or temporarily stops an operation involved, the CPU 14 ends the processing.

Incidentally, as the above-mentioned processing step, a lunch AD. may be automatically displayed on all the extension terminals for example at 11:30 A.M. or, if the user on the extension terminal 2-1 enters a ┌lunch/LUNCH┘ from a dial pad on that extension terminal, an associated AD. may be displaced.

In the embodiment above, the purchasing center BO buys a creation support tool for setting an AD, script to the contracting PBX 1 from the exchange apparatus maker MK and, without studying and reviewing any setting environment of the owner's PBX 1 as well as any data format of a control program, a script creator unfamiliar with any expertise on the field creates an AD. script suited to the respective PBX 1 through the utilization of the creation support tool and provides this AD. script to the PBX 1.

The purchasing center BO can largely reduce the labor and cost necessary to the creation of the AD. script and earn more money under an AD. script presenting effect. On the other hand, the user on the extension terminal 2 can promptly look and hear any newly created or version-up AD. information. In this way, the user can ensure more enhanced entertainment, more stimulated buying desire for the AD. appearing commodities or service. For the exchange apparatus maker MK it is possible to obtain more money corresponding to the creation support tool and also get more stimulated desire for script AD. creation.

In the above-mentioned embodiment, the owner of the PBX 1 can obtain an expense for setting an AD. script to the PBX 1 from the purchasing center BO. In this way, it is possible to gain more enhanced AD. effect on which more owners are jointed to get more AD. script. On the other hand, for the purchasing center BO it is possible to expect more memory from the AD. script-appearing commodities and service.

Further, in this embodiment, since the purchasing center BO requests the exchange apparatus dealer DL to set the AD. script to the PBX 1, the purchasing center BO has only to create and AD. script and can alleviate the processing burden thereon.

In the embodiment above, the transfer of the AD. script to the PBX 1 is made through the external memory 3 and it is possible to provide the AD. script to the owner of the contracting PBX 1 without the need to build any new infrastructure involved.

In the embodiment above, the PBX 1 allows the AD. script to read in according to the set execution condition and, after processing the AD. script, displays it on the respective extension terminal 2. Where, on the other hand, the extension terminal 2-1 is available, for example, the AD. information is displayed on the display device LCD1 of the associated extension terminal 2-1 and the AD. information is displayed on the display device LCD2 of the extension terminal 2-2 by a select instruction from the user on the extension terminal 2-2. In the way it is possible to selectively provide the AD. information to the respective extension terminal 2 in accordance with the set execution condition.

The present invention is not restricted to the above-mentioned embodiment. Although, in the embodiment above, the banner AD. display has been explained as a method for displaying the AD. on the extension terminal 2, the present invention is not restricted thereto and the AD. can be delivered as a voice from a speaker on the extension terminal 2.

The extension terminal 2 may effect a signal delivery to the purchasing center BO by, for example, a dial operation and the order of the commodities may be placed by one operation. In this case, an order amount can be recorded for each extension number, a total amount can be automatically displayed on the respective extension terminal at the end of each month, a mail can be transmitted to the purchase center BO, associated information can be transmitted to a salary management system of a PBX 1-available business office and, after deducting a given amount from the salary of the user on the extension terminal 2, can remit a balance to the purchasing office BO, and so on.

Although, in the embodiment above, the purchasing center BO has been explained as buying the creation support tool from the exchange apparatus maker MK, the creation support tool may be bought from the exchange apparatus dealer DL if the exchange apparatus dealer DL possesses the creation support tool.

Although, in the embodiment above, the purchasing center BO has been explained as requesting the exchange apparatus dealer DL to set the created AD. script to the PBX 1, the present invention is not restricted thereto and, instead, the request may be made to the exchange maker MK or the script cheater may directly visit the office to set the AD. script to the PBX 1 on the office.

Although, in the embodiment above, the transfer of the AD. script to the PBX 1 is mode through the external memory 3, if, for example, the public network NW is comprised of the Internet and connection can be made between the PBX 1 and the purchasing center BO through an information transmit channel, the AD. script may be forwarded through the information transfer channel. If this is the case, it is possible to deliver a newly created or version-up AD. script efficiently in a short time and the user on the respective extension terminal 2 can see and hear the new AD. information at all times.

In the above-mentioned embodiment, if a plurality of AD. scripts of mutually different contents are recorded on the RAM 15 in the PBX 1, an individual execution condition may be set for each script. In this case, when a lunch time for example comes, AD. information on the lunch can be sent to the respective extension terminal 2 for presentation. If a keyword “automobile” for example is entered at any extension terminal 2-3, then AD. information on the “automobile” can be sent to the extension terminal 2-3. In this way, in accordance with the condition's content, any optimal AD. information can be sent to corresponding extension terminals 2 for presentation on the display device.

Although, in the embodiment above, an explanation has been made about the PBX 1 where the respective extension terminals 2 are connected through extension lines, the present invention is not restricted thereto. For example, the present invention can be applied to a network telephone system where connection is made between the exchange apparatus and extension terminals, for example, through a communication network such as a LAN.

With respect to the structure of the communication system, kinds of PBXs and their structure, kinds of extension terminals, presentation procedure of the AD. script, display method of the AD. information, and so on, various changes and modifications of these can be made without departing from the essence of the present invention and the present invention can be put to practice based on them.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A method for use in a communication system which includes an user apparatus equipped with an exchange apparatus connected to a plurality of extension terminals, and a purchasing center adapted to communicate with the exchange apparatus together with the extension terminal via a communication network based on a control program be setting the exchange apparatus, the extension terminal receiving a buying/presenting information allowing the buying at least one of commodities and service through the communication network, and making a call/connection to the purchasing center through the communication network based on a purchasing center-connecting information contained in the buying/presenting information and taking a buying procedure, in response to a buying instruction, comprising:
acquiring creation support information for creating the buying/presenting information in a data format of the control program at the purchasing center;
creating the buying/presenting information based on the creation support information;
obtaining the buying/presenting information at the user apparatus;
recording the obtained buying/presenting information on a recording medium at the user apparatus; and
reading out the buying/presenting information from the recording medium in accordance with an initially set condition and selectively transmitting the buying/presenting information to the plurality of extension terminals at the user apparatus.

2. A method according to claim 1, wherein the purchasing center communicates with at least one of a maker of the exchange apparatus and a dealer engaged in sales business on behalf the exchange apparatus, to buy the creation support information from at least one of the maker and the dealer.

3. A method according to claim 1, wherein the purchasing center pays an expense for setting the buying/presenting information to the exchange apparatus to the user possessing the exchange apparatus.

4. A method according to claim 1, wherein the purchasing center requests at least one of the maker and the dealer, to set the buying/presenting information to the exchange apparatus.

5. A telephone exchange apparatus connected to a plurality of extension terminals, and adapted to communicate with a purchasing center via a communication network based on an initially set control program, the extension terminal receiving a buying/presenting information allowing the buying at least one of commodities and service through the communication network, and making a call/connection to the purchasing center through the communication network based on a purchasing center-connecting information contained in the buying/presenting information and taking a buying procedure, in response to a buying instruction, the telephone exchange apparatus comprising:
an acquiring device configured to selectively acquire the buying/presenting information created in a data format of the control program data by the purchasing center;
a recorder which records the buying/presenting information on a recording medium; and
a controller which controls to read out the buying/presenting information from the recording medium in accordance with an initially set execution condition and selectively transmit the buying/presenting information to the plurality of extension terminal.

6. A telephone exchange apparatus according to claim 5, further comprising an input/output device mounted on a portable type memory medium, and wherein the acquiring device reads the buying/presenting information therein from the portable type memory medium, when the portable type memory medium with the buying/presenting information stored therein is attached to the input/output device.

7. A telephone exchange apparatus according to claim 5, wherein the acquiring device acquires the buying/presenting information from the purchasing center via the information transmit channel in accordance with a buying/pressing information setting request coming via the information transmit channel from the purchasing center, when the communication network has an information transmit channel adapted to transmit the buying/presenting information.

8. A telephone exchange apparatus according to claim 5, wherein the controller judges the execution condition based on at least one of an operation state of each of extension terminals, time/date information and instruction from the extension terminal.

9. A telephone exchange apparatus according to claim 5, wherein the controller manages the execution conditions of respective transmit buying/presenting information in a form matched to the buying/presenting information, when a plurality of mutually different buying/presenting information are recorded on the recording medium.

10. A telephone exchange apparatus according to claim 5, wherein the buying/presenting information contains any specified abridged connection information at a time of operating at least one operation key on the extension terminal,
further comprising a connector which connects to the purchasing center via the communication network based on the abridged connection information, when the operation key corresponding to the abridged connection information is depressed.
